(19) United States
(12) Patent Application Publication
(10) Pub. No.: US 2025/0136067 A1
(43) Pub. Date: May 1, 2025

(54) VEHICLE MOUNT

(71) Applicant: J & J Solutions & Innovations Pty Limited, Panania (AU)

(72) Inventor: Con ANNIS, Panania (AU)

(73) Assignee: J & J Solutions & Innovations Pty Limited, Panania (AU)

(21) Appl. No.: 18/824,424

(22) Filed: Sep. 4, 2024

(30) Foreign Application Priority Data
Sep. 6, 2023 (AU) 2023902869

(51) Int. Cl. B60S 9/04

(52) U.S. Cl. CPC B60S 9/04

(57) ABSTRACT

The present disclosure is directed to a vehicle mount comprising a substantially planar base having opposing upper and lower faces and including a plurality of spaced apart slots. The vehicle mount further comprises a support saddle mount extending from the lower face of the base, the saddle mount configured to releasably mount to an upper end of a vehicle support stand centre column or a saddle member mounted about the upper end of the centre column. The vehicle mount further comprises a support pad mounted to the upper face of the base.

### CROSS-REFERENCE TO RELATED APPLICATION

The present application claims the priority of Australian provisional application number 2023902869 filed 6 Sep. 2023 and entitled “Vehicle Mount”, the entire contents of which is hereby incorporated herein by reference.

### FIELD OF THE INVENTION

The present invention relates to devices for supporting heavy loads such as motor vehicles. In particular, the devices have adjustable heights to support a load such as a vehicle at different elevations above a support surface.

### BACKGROUND

It is often necessary to lift and support heavy equipment at a certain height above a floor or ground surface. Most automotive mechanics have vehicle mount devices to support a motor vehicle at a height above the floor for better access to the underside of the vehicle. These height adjustable devices are commonly referred to as jack stands. Jack stands are typically used in conjunction with a vehicle jack.

Vehicle jacks are devices used to lift motor vehicles to a required height above the supporting ground surface. Normally the jack is placed under the vehicle at one of the designated jacking points. Often there are four jacking points positioned at an outer section of the sill panel which is a structurally vital panel that runs under the vehicle doors between the front and rear wheel arches. The height of the jack is raised (via a mechanism providing the user with sufficient mechanical advantage) until it engages the jacking point and raises the vehicle.

To keep that section raised, a jack stand is adjusted to the desired height and placed at the structurally reinforced section of the sill panel or chassis rail. The vehicle is then generally lowered using the jack until the jacking point engages the top of the jack stand. The process can be repeated at another section until the entire vehicle is supported above the floor by four or more jack stands if required. In some situations, only two jack stands are used to hold either the front end of the vehicle elevated or the rear end elevated. The wheels remaining on the ground will usually be chocked to prevent the car moving while elevated from the ground.

In some situations, it may be advantageous to support a vehicle at a location other than one of the designated jacking points. Unfortunately, jack stands are unlikely to securely engage any part of the vehicle underside other than the designated jacking points. Similarly, using a jack stand in positions other than the jacking points is likely to damage the sill on the underside of the vehicle as only the jacking points along the sill are reinforced.

### SUMMARY OF THE INVENTION

According to an aspect of the invention there is provided a vehicle mount comprising:
a substantially planar base having opposing upper and lower faces and including a plurality of spaced apart slots;
a support saddle mount extending from the lower face of the base, the saddle mount configured to releasably mount to an upper end of a vehicle support stand centre column or a saddle member mounted about the upper end of the centre column; and
a support pad mounted to the upper face of the base.

According to another aspect of the invention there is provided a vehicle stand comprising:
a base extending between a lower support surface end and an upper end;
a centre column for inter-engagement with the base, the column having spaced apart locking configurations and the base having a locking mechanism to selectively engage the locking configurations to lock the column in one of a plurality of positions relative to the base, an upper end of the centre column including a contact platform; and
a vehicle mount according to the first aspect of the invention mounted to the upper end of the centre column.

According to another aspect of the invention there is provided a vehicle stand for supporting a vehicle at a height above a support surface, the vehicle mount comprising:
a base for resting on the support surface;
a support member for inter-engagement with the base, the support member having locking configurations and the base having a locking mechanism to selectively engage the locking configurations to lock the support member in a plurality of locked positions relative to the base;
the support member having a contact platform for engagement of the vehicle, the contact platform being mounted to the support member for supporting a vehicle at different heights above the support surface, the different heights corresponding to each of the plurality of locked positions;
wherein the contact platform includes a resilient pad to contact the vehicle.

It can be seen there is advantageously provided a vehicle mount and a vehicle stand that allows a vehicle to be supported at other than the typically four designated jacking points without damage to the vehicle sill or underside of the vehicle.

### BRIEF DESCRIPTION OF THE DRAWINGS

A preferred embodiment of the present invention will now be described by way of example only with reference to the accompanying drawings, in which:

FIG. 1 shows a jack stand according to the prior art;

FIG. 2 shows a vehicle mount according to a preferred embodiment with a support member in an unextended configuration;

FIG. 3a shows a support member of the mount of FIG. 2 in the form of a support bar with saw tooth locking profiling along one edge for ratchet engagement with the locking mechanism of the base:

FIG. 3b shows the support shaft of a jack stand of the prior art in FIG. 1;

FIG. 4 shows the support platform for the vehicle mount of FIG. 2;

FIG. 5 shows the underside of the support platform for the vehicle mount FIG. 4;

FIG. 6 shows the contact pad for the platform of FIG. 4;

FIGS. 7a and 7b shows two of the vehicle mounts holding a motor vehicle at an elevated position above a supporting surface;

FIGS. 8a and 8b show various components of a vehicle mount according to the preferred embodiment of FIG. 2;

FIG. 9 shows vehicle mounts according to a preferred embodiment positioned under a vehicle;

FIG. 10 shows various components of a vehicle mount according to a preferred embodiment;

FIG. 11 shows various components of a vehicle mount according to a preferred embodiment;

FIG. 12 shows various components of a vehicle mount according to a preferred embodiment;

FIG. 13 shows various components of a vehicle mount according to a preferred embodiment;

FIG. 14 shows various components of a vehicle mount according to a preferred embodiment;

FIG. 15 shows various components of a vehicle mount according to a preferred embodiment;

FIG. 16 shows various components of a vehicle mount according to a preferred embodiment; and

FIG. 17 shows various components of a vehicle mount according to a preferred embodiment.

### DETAILED DESCRIPTION OF PREFERRED EMBODIMENTS

Referring to the drawings generally, like reference numerals have been used to denote like components unless expressly stated otherwise.

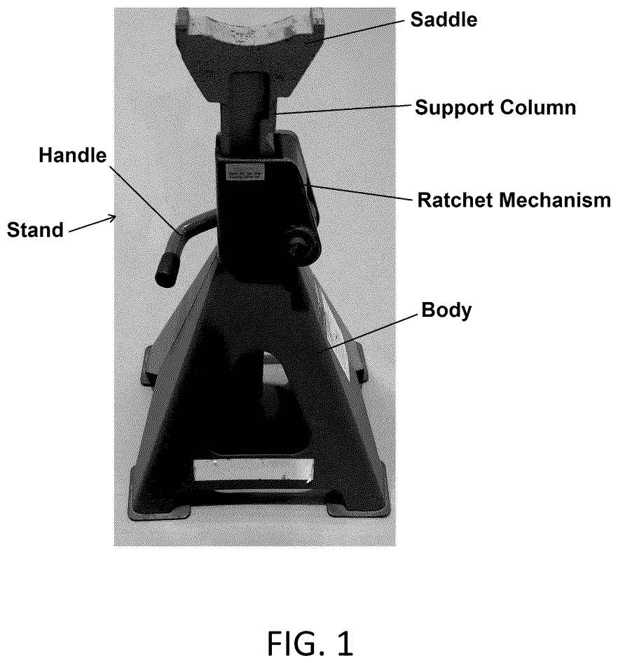

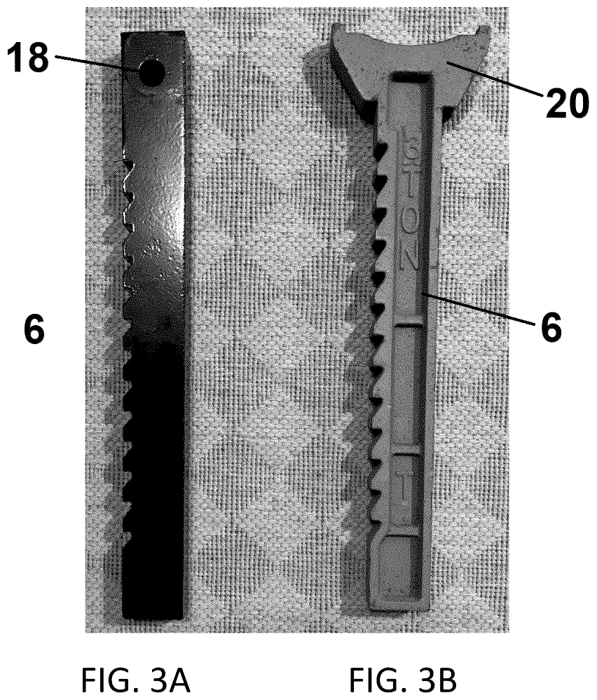

FIG. 1 shows a typical jack stand that is known and used in many commercial and domestic garages. FIG. 3b shows a support member of the jackstand of FIG. 1.

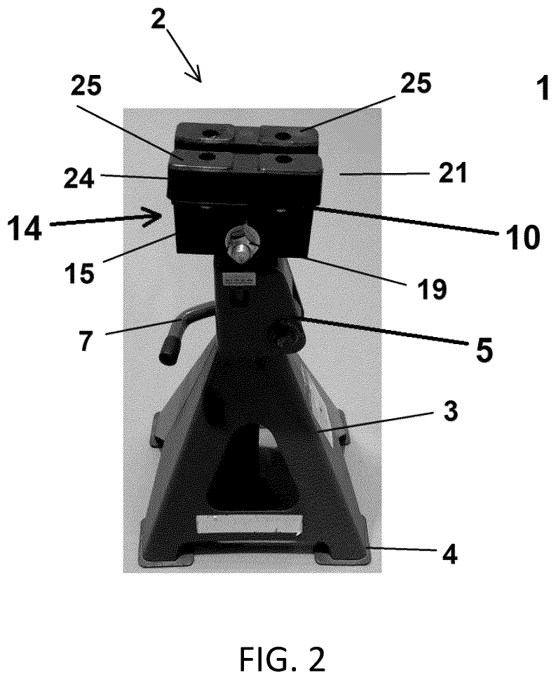

In FIGS. 2, 3a & 4 to 15, a vehicle stand 1 according to the preferred embodiment includes a vehicle mount 2. Stand 1 includes a body 3 supported at a lower end by flared feet 4 and extends a predetermined height terminating at a ratchet locking mechanism 5. A toothed centre column or support member 6 is engaged with the ratchet mechanism 5 and extends from within the body 3 where the centre column 6 is movable between predetermined positions defined by the column teeth.

The ratchet mechanism 5 of the preferred embodiment includes a handle 7 movable to lock and unlock the centre column. The centre column 6 having spaced apart locking teeth for corresponding locking configurations in the base with locking mechanism 5 allows the selective engagement the locking configurations to lock the column in one of a plurality of height positions relative to the body 3.

The vehicle mount 2 includes a planar base 10 formed from steel. Base 10 includes opposing upper 11 and lower 12 faces, a pair of slots 13 as described further below. A support saddle mount 14 extends a predetermined distance from the lower face 12 of the base 10. The support saddle mount 14 is formed from a pair of saddle support arms 15 & 16 that are attached to the base lower face 12 extending a predetermined distance away from face 12.

The saddle mount 14 configured to releasably mount to an upper end of the vehicle support stand centre column 6 and in the preferred embodiment base 10 is mounted to abut the upper end of the centre column 6. To releasably secure base 10 to centre column 6, the saddle support arms 15 & 16 each include an aperture 17 & 18 that aligns with an aperture 19′ disposed adjacent to the end of the centre column 6. Apertures 17 & 18 receive a locking bolt 19 therethrough to releasably attach the arms 15 & 16.

In other embodiments, a fastener or pin located through apertures 17 & 18 can be used as desired. Although not clearly illustrated, the upper end of the centre column 6 may or may not have a saddle member 20. It will be appreciated that in other embodiments, not illustrated, the saddle support arm apertures 17 & 18 or the centre column aperture 19′ can be threaded for engagement with a locking fastener rather than the use of unthreaded apertures and a through bolt of the preferred embodiment.

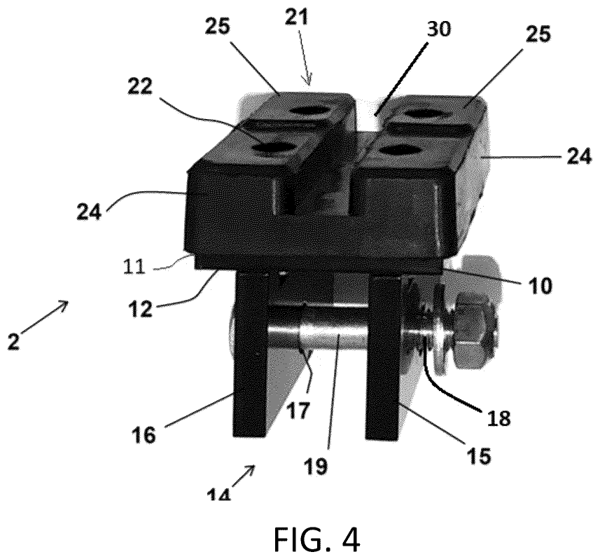

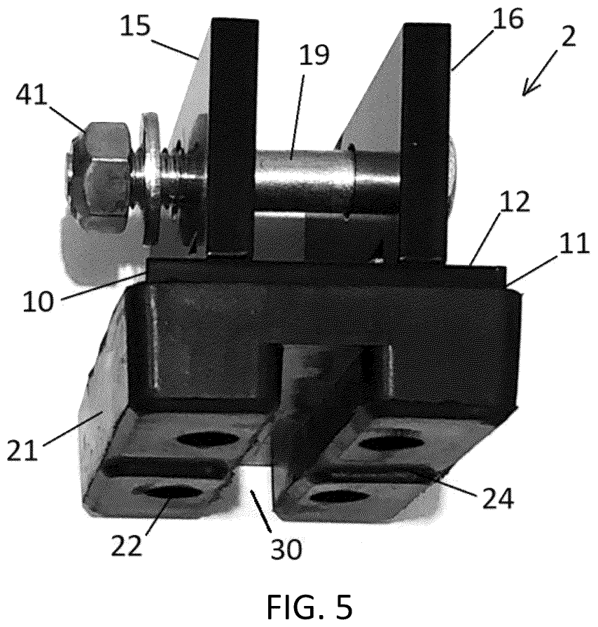

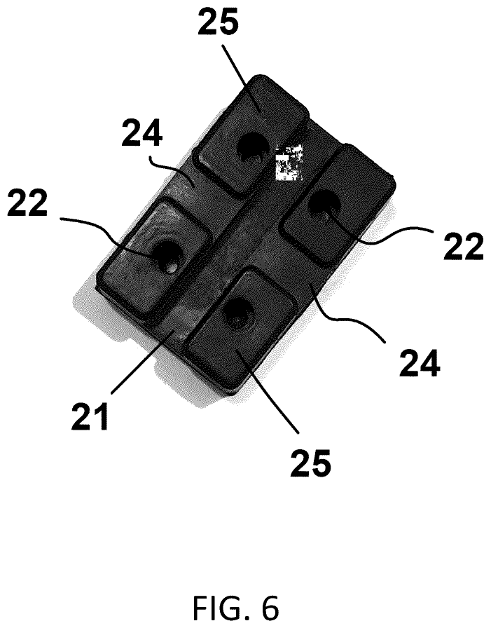

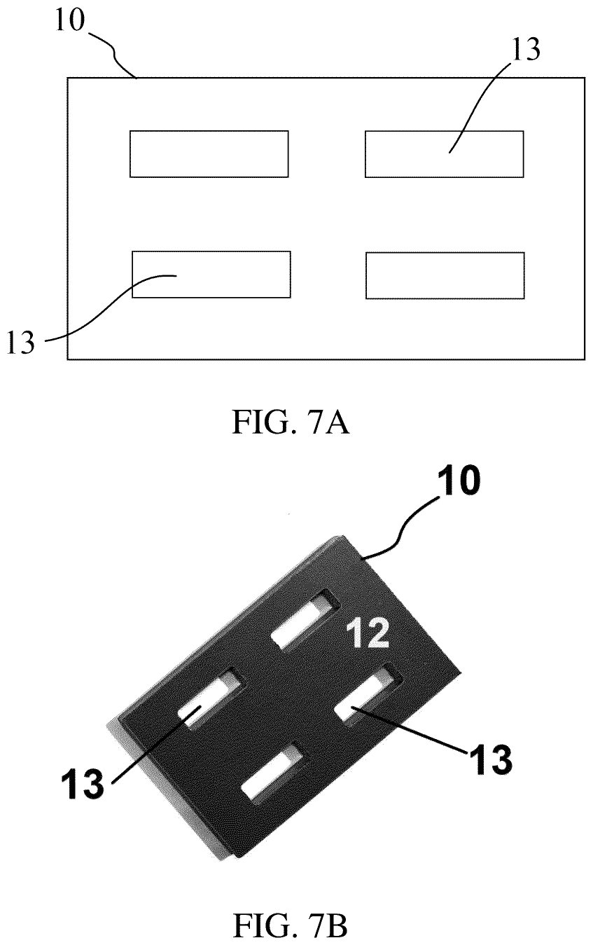

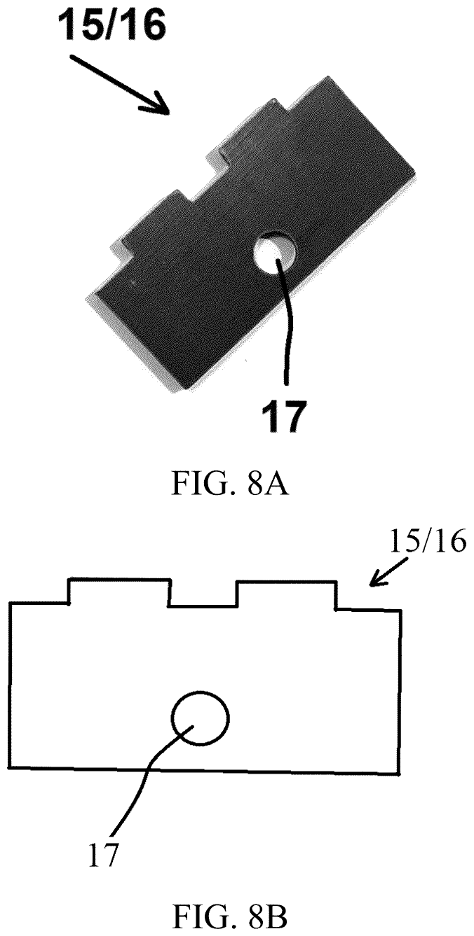

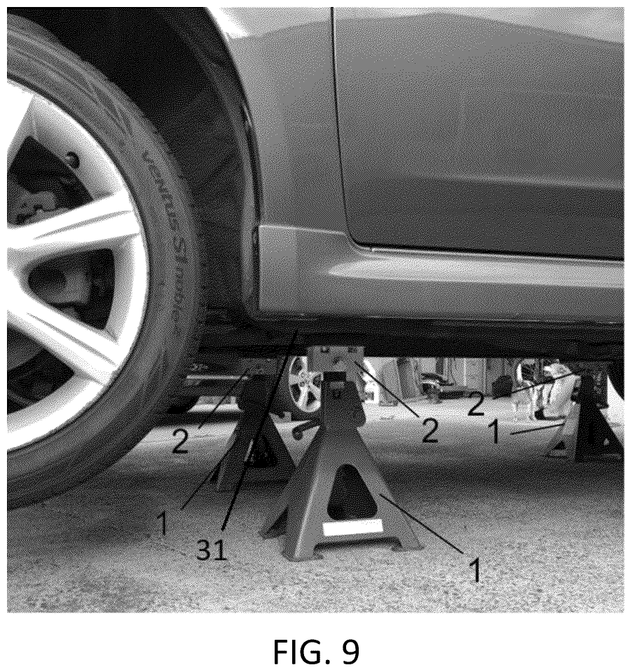

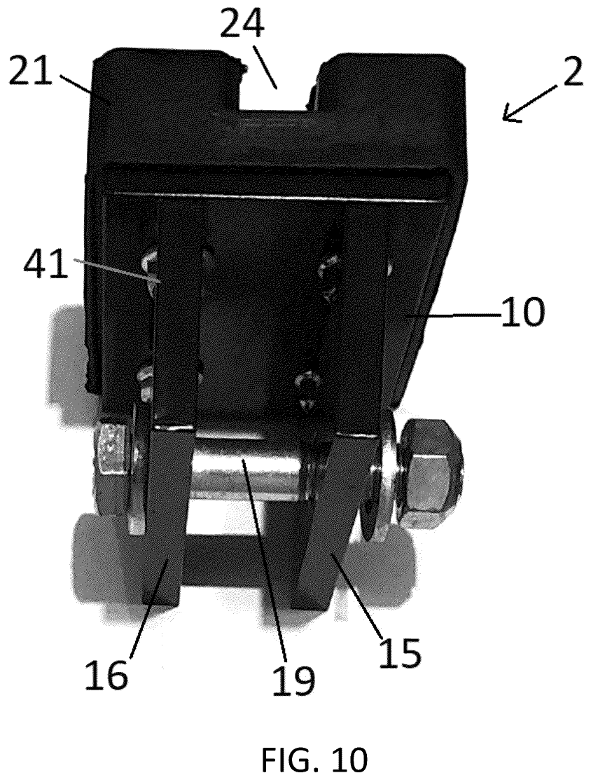

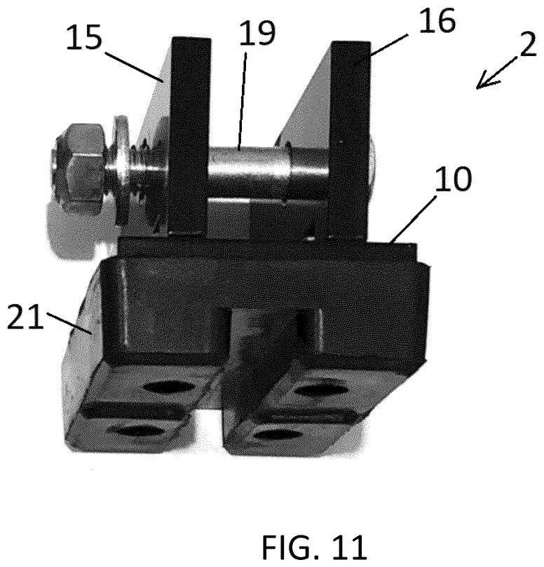

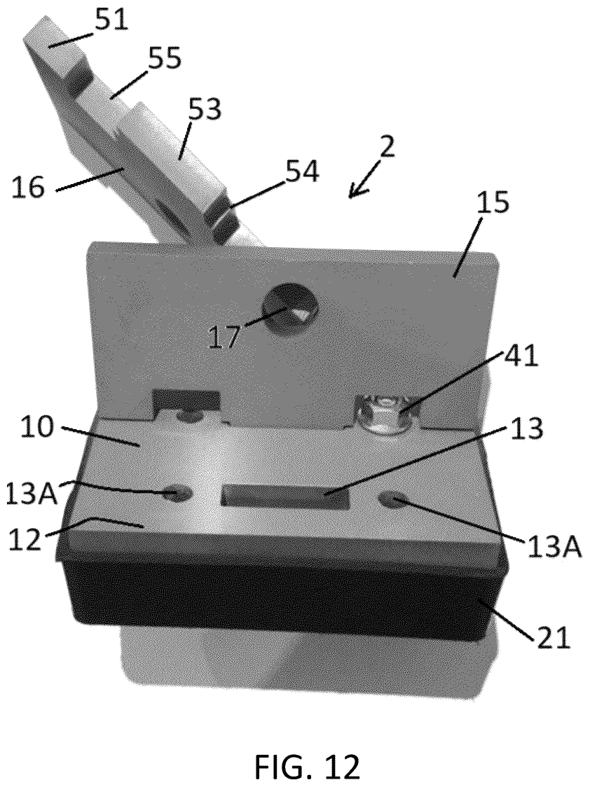

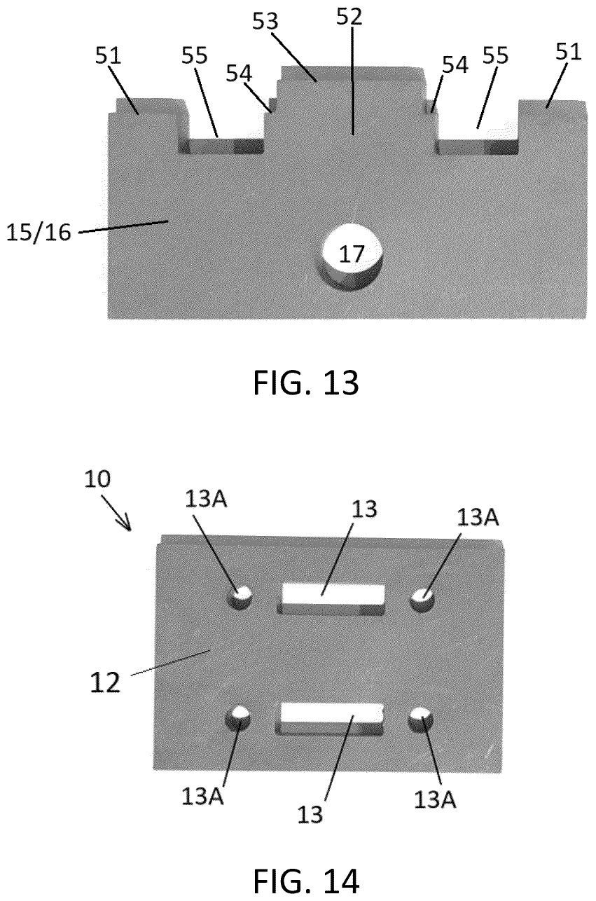

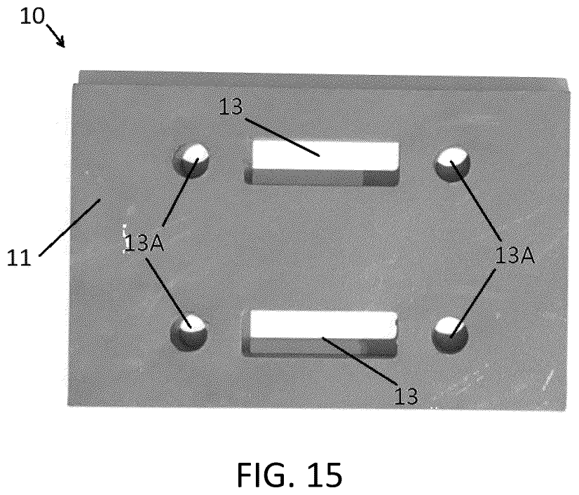

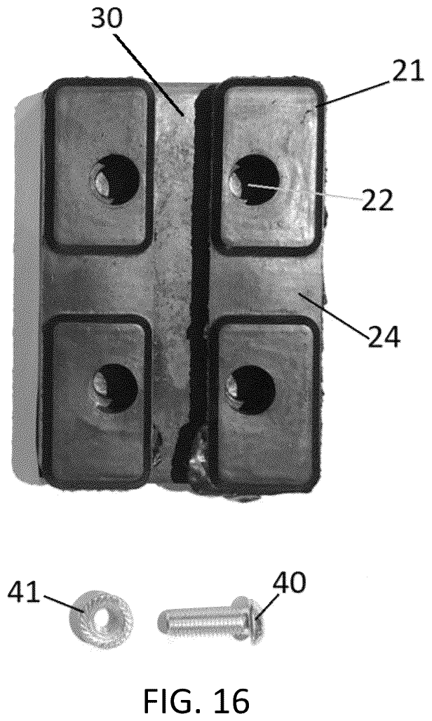

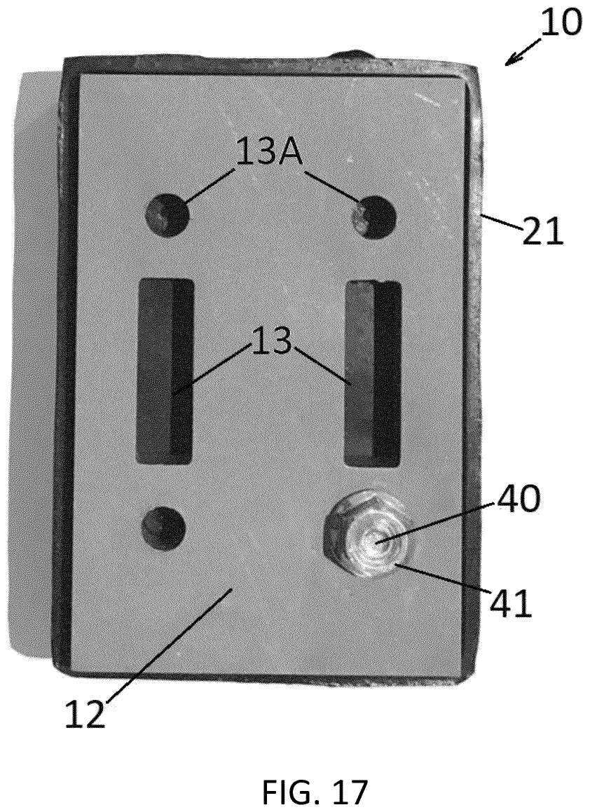

As shown in the drawings, a support pad 21 is disposed across the upper face 11 of the base 10. Pad 21 extends away from base face 11 and the end of centre column 6 and includes apertures 22 that respectively spatially correspond to respective base apertures 13A. It can be seen pad apertures 22 receive a fastener 40 (not clearly illustrated in FIGS. 1 to 7, best seen in the components of the mount 2 shown in of FIGS. 8 to 15 described below) to extend through apertures 13A secure to base 10.

The support pad 21 is formed from a resilient material rubber-like material that can conform to a predetermined extent to the vehicle shape at an engagement point 30. Any preferred elastomer can be used, however. Pad 21 further includes a pair of notches 24 extending from a face thereof away from pad 21 and base face 11. It can be seen notches 24 are spaced apart to receive a mount point projection (lower sill 31 as shown in the preferred embodiment with a vehicle on a plurality of stands 1) of the vehicle and are bridged by pad 21. It is noted abutment face 25 engages the vehicle and notches 24 or a bottom thereof does not contact the bottom of the vehicle. In the preferred embodiment it will be appreciated the vehicle adjacent sill 31 is supported by engagement point 30.

The resilient pad 21 of the preferred embodiment is a wear-resistant rubber pad with compressive strength greater than 12 megapascals and preferably in the range of 10 Mpa to 30 Mpa. Further, the compression deformation of the pad 21 including abutments 24 under an applied full load is less than 12% of the pad thickness (or height being from the base 10 to the abutment face 25). Preferably, the compression deformation at full rated load is less than 30%. As would be understood, any high compression set resistant elastomer can be used.

The mount 2 can be fixed to or adjacent to the centre column 6 upper end and it will be appreciated mount 2 can be disposed at any preferred angle in a plane parallel to the axis of elongation of column 6. Although not clearly shown, mount 2 can be disposed at different angular positions relative to the support vehicle stand centre column 6 upper end whether column 6 terminates in a saddle or not.

In this way, the mount 2 is hingedly connected to or adjacent to the upper portion of the centre column 6. However, in other preferred embodiments of the invention (not illustrated) base 10 is pivotably mounted to the centre column 6. Further, saddle support arms 15 & 16 can each have a plurality of laterally spaced apart apertures 17 & 18 so as to define predetermined angular positions for the base 10 and hence mount 2.

Referring now to FIGS. 8 to 15, there is shown components of the mount 2 of the preferred embodiment. Mount 2 also includes a planar base 10 preferably formed from steel. Base 10 includes opposing upper 11 and lower 12 faces having a pair of parallel slots 13 and a apertures 13A spaced apart from the end of each slot 13 to receive pad retaining means 40. A support saddle mount 14 extends a predetermined distance from the lower face 12 of the base 10. The support saddle mount 14 is formed from a pair of saddle support arms 15 & 16 that are attached to the base lower face 12 extend a predetermined distance away from face 12.

The saddle mount 14 is adapted for releasably affixing mount 2 to an upper end of the vehicle support stand centre column 6 (not shown in FIGS. 8 to 15). As shown in FIG. 2, base 10 is configured to abut the upper end or saddle of the centre column 6.

To releasably secure base 10 to centre column 6, parallel saddle support arms 15 & 16 are attached to face 12 and extend therefrom. Rather than engagement tabs extending from arms 15 & 16 projecting into respective slots 13, arms 15 & 16 in this embodiment each include lateral tabs 51 configured to abut face 12 of base 10, and a central engagement tab 52 having a head 53 configured to be received in respective slots 13.

A shoulder portion 54 is disposed on each side of tab 52 and configured to abut face 12. Preferably, tab 52 is welded about slot 13 on either or both faces 11 & 12 as desired. It will be appreciated tabs 51 abut body face 12 but can also be welded to face 12 if desired.

Each arm 15 & 16 intermediate each lateral tab 51 and central tab 52 includes an arm void 55 to accommodate securement of pad 21 as described below. In a similar manner to the first embodiment, arms 15 & 16 are preferably welded to base 10 at at least central tab 52.

Each arm 15 & 16 includes an aperture 17 & 18 that aligns with an aperture 19′ disposed adjacent to the end of the centre column 6 (again not illustrated in FIGS. 8 to 15). Apertures 17 & 18 receive a locking bolt 19 through column aperture 19′ to releasably attach the arms 15 & 16. Alternatively, a fastener or pin can be located through apertures 17 & 18 in place of locking bolt 19 if desired.

Support pad 21 is disposed across the upper face 11 of the base 10. Pad 21 extends away from base face 11 (and the end of centre column 6 when attached) and includes apertures 22 that respectively spatially correspond to respective base apertures 13A. Pad apertures 22 receive a fastener 40 to extend through apertures 13A to secure pad 21 to base 10. Although fastener 40 of the second embodiment includes a locking nut, it will be appreciated apertures 13A can be tapped or threaded.

When pad 21 is attached to the base 10, each arm void 55 is configured to receive a nut 41. Voids 55 may be unnecessary when apertures 13A are tapped and fastener 40 does not project beyond lower face 12 of the base 10.

As with the first embodiment, the support pad 21 can be composed of any desired material and is preferably formed from a resilient material rubber-like material that can conform to a predetermined extent to the vehicle shape at an engagement point 30. Any preferred elastomer can be used, however, pad 21 further includes a pair of notches 24 to receive a mount point projection of the vehicle and are bridged by pad 21. Each notch 24 is surrounded by engagement or abutment face 25 and no vehicle contact is made with the bottom of notch 24.

The resilient pad 21 as with the first embodiment is preferably wear-resistant and rubber pad with compressive strength greater than 12 megapascals with the same compression deformation characteristics.

The preferred embodiment of FIGS. 8 to 15 also allows mount 2 to be relatively fixed to or adjacent to the centre column 6 upper end and it will be appreciated mount 2 can also be disposed at any preferred angle in a plane parallel to the axis of elongation of column 6. The mount 2 can be hingedly connected to or adjacent to the upper portion of the centre column 6 or be pivotably mounted to the centre column 6. Although not illustrated and similarly to the first embodiment, saddle support arms 15 & 16 can each have a plurality of laterally spaced apart apertures 17 & 18 so as to define predetermined angular positions for the base 10 and mount 2.

It can be seen there is advantageously provided a vehicle stand able to support a vehicle at a point along a lower sill that will minimise or eliminate any damage to the vehicle at or about the jack contact point/s. Further, jack stands having a saddle at the upper end of the centre column 6 can employ mount 2 to avoid vehicle damage that is likely regardless of the saddle orientation.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A vehicle mount comprising:
a substantially planar base having opposing upper and lower faces and including a plurality of spaced apart slots;
a support saddle mount extending from the lower face of the base, the saddle mount configured to releasably mount to an upper end of a vehicle support stand centre column or a saddle member mounted about the upper end of the centre column; and
a support pad mounted to the upper face of the base.

2. A mount according to claim 1 wherein the support pad includes apertures each spatially corresponding to a respective base apertures, the pad apertures configured to receive a fastener head.

3. A mount according to claim 1 wherein the support saddle mount includes a pair of spaced apart saddle support arms extending a predetermined distance from the base lower face, the saddle support arms being configured to be disposed about the vehicle support centre column such that an end of the centre column abuts the base lower face.

4. A mount according to claim 3 wherein the saddle support arms each include an aperture configured to align with an aperture disposed adjacent to the upper end of the centre column, and to receive a fastener or pin through the saddle support arms and centre column.

5. A mount according to claim 4 wherein one of the support arm apertures is threaded.

6. A mount according to claim 4 wherein the saddle support arm apertures or the centre column are threaded.

7. A mount according to claim 1 wherein the support pad is formed from a resilient material and includes a pair of spaced apart notches connected at a lower end by a bridge, each notch terminating at any engagement face the distal bridge.

8. A mount according to claim 7 wherein the support pad apertures extend through the pad from the engagement face.

9. A mount according to claim 7 wherein the notches are spaced apart to receive a vehicle lower sill seam structure therebetween.

10. A mount according to claim 1 configured to be mounted at different angular positions relative to the support vehicle stand centre column upper end or saddle.

11. A vehicle stand comprising:
a base extending between a lower support surface end and an upper end;
a centre column for inter-engagement with the base, the column having spaced apart locking configurations and the base having a locking mechanism to selectively engage the locking configurations to lock the column in one of a plurality of positions relative to the base, an upper end of the centre column including a contact platform; and
a vehicle mount according to claim 1 mounted to the upper end of the centre column.

12. A vehicle stand for supporting a vehicle at a height above a support surface, the vehicle stand comprising:
a base for resting on the support surface;
a support member for inter-engagement with the base, the support member having locking configurations and the base having a locking mechanism to selectively engage the locking configurations to lock the support member in a plurality of locked positions relative to the base;
the support member having a contact platform for engagement of the vehicle, the contact platform being mounted to the support member for supporting a vehicle at different heights above the support surface, the different heights corresponding to each of the plurality of locked positions;
wherein the contact platform includes a resilient pad to contact the vehicle.

13. A stand according to claim 12 wherein the contact platform is pivotably mounted to the support member.

14. A stand according to claim 12 wherein the contact platform is hingedly connected to an upper portion of the support member.

15. A stand according to claim 14 wherein the contact platform is hingedly connected to the support member, and the contact platform is configured for locking the support member at different angular positions relative to the contact platform.

16. A stand according to claim 12 wherein the resilient pad is a wear-resistant rubber pad with compression strength greater than 12 megapascals.

17. A stand according to claim 12 wherein the resilient pad has a compression deformation at full load of less than 12%, or less than 30%.
